(19) United States
(12) Patent Application Publication
(10) Pub. No.: US 2025/0174418 A1
(43) Pub. Date: May 29, 2025

(54) ELECTRIC CIRCUIT SWITCHING DEVICE

(71) Applicant: Daicel Corporation, Osaka-shi, Osaka (JP)

(72) Inventors: Tomohiro TSUDA, Tokyo (JP); Masahiro TSURUTA, Tokyo (JP); Tsuneki KONISHI, Tokyo (JP); Jackkrit SABMEK, Tokyo (JP)

(73) Assignee: Daicel Corporation, Osaka-shi, Osaka (JP)

(21) Appl. No.: 18/839,729

(22) PCT Filed: Feb. 25, 2022
(86) PCT No.: PCT/JP2022/008023

§ 371 Date: Aug. 20, 2024

(51) Int. Cl. H01H 39/00

(52) U.S. Cl. CPC H01H 39/006; H01H 2039/008

(57) ABSTRACT

An electric circuit switching device includes a housing; an igniter configured to release a combustion gas upon actuation; a tubular space formed in the housing; a projectile having conductivity and positioned at a predetermined first position in the tubular space in an initial state; a piston fixed to the projectile and disposed in the tubular space interposedly between the igniter and the projectile, and configured to be projected in a predetermined projecting direction by energy of the combustion gas; and a pair of first conductor pieces provided inserted, in a spaced apart state, into the tubular space at a position closer to the projecting direction side than the first position. The projectile projected integrally with the piston upon actuation of the igniter comes into contact with each of the pair of first conductor pieces, switching the first electric circuit from an interrupted state to a conductive state.

### TECHNICAL FIELD

The present invention relates to an electric circuit switching device.

### BACKGROUND ART

There are known relays that protect an electric device by switching a specific electric circuit from an interrupted state to a conductive state when an abnormality occurs in the electric device. As such relays, there are known electromagnetic relays that utilize electromagnets to switch the opening and closing of the electric circuit. However, known electromagnetic relays take a long time to switch to the conductive state, causing problems such as the occurrence of a defect in which the electric device fails due to the effects of excessive current, for example.

### CITATION LIST

### Patent Literature

Patent Document 1: US 2015/248,979 A

Patent Document 2: WO 2016/169612

Patent Document 3: WO 2020/164871

### SUMMARY OF INVENTION

### Technical Problem

An object of the technology of the present disclosure is to provide an electric circuit switching device for switching a predetermined electric circuit from an interrupted state to a conductive state, the electric circuit switching device being capable of shortening a time required for switching.

### Solution to Problem

To solve the above problems, the electric circuit switching device according to the present disclosure adopts the following configuration. That is, the technology of the present disclosure is an electric circuit switching device configured to switch a predetermined first electric circuit from an interrupted state to a conductive state upon actuation. The electric circuit switching device includes a housing; an igniter provided in the housing and configured to release a combustion gas upon actuation; a tubular space formed in the housing and extending in one direction; a projectile having conductivity and positioned at a predetermined first position in the tubular space in an initial state before actuation of the igniter; a piston fixed to the projectile and disposed in the tubular space interposedly between the igniter and the projectile, and configured to be projected in a predetermined projecting direction along the tubular space by energy of the combustion gas; and a pair of first conductor pieces provided inserted, in a spaced apart state, into the tubular space at a position closer to the projecting direction side than the first position, and forming part of the first electric circuit in cooperation with each other. The projectile projected integrally with the piston upon actuation of the igniter comes into contact with each of the pair of first conductor pieces, switching the first electric circuit from the interrupted state to the conductive state.

Further, the electric circuit switching device according to the present disclosure may be configured to further switch a predetermined second electric circuit from a conductive state to an interrupted state upon actuation. The electric circuit switching device may further include a pair of second conductor pieces provided inserted, in a spaced apart state, into the tubular space, and forming part of the second electric circuit in cooperation with each other. In the initial state, the pair of second conductor pieces may be electrically connected to each other via the projectile, causing the second electric circuit to be in the conductive state. An electrical connection between the pair of second conductor pieces via the projectile may be disconnected when the projectile is projected in the projecting direction, switching the second electric circuit from the conductive state to the interrupted state.

Further, in the electric circuit switching device according to the present disclosure, in the initial state, the projectile may be interposed between the pair of second conductor pieces, the projectile being integrally connected with the pair of second conductor pieces, and the projectile may be separated from each of the pair of second conductor pieces by the energy of the combustion gas.

Further, in the electric circuit switching device according to the present disclosure, the projectile may include a base body positioned in the first position in the initial state, and a pair of protrusions protruding from the base body in the projecting direction. Each of the pair of first conductor pieces may be provided with an insertion hole into which a corresponding one of the pair of protrusions of the projectile projected is insertable. Each of the pair of protrusions may come into contact with an edge portion of the insertion hole, switching the first electric circuit from the interrupted state to the conductive state.

Further, in the electric circuit switching device according to the present disclosure, a wedge portion having a wedge shape may be formed on a distal end side of each of the pair of protrusions.

Further, in the electric circuit switching device according to the present disclosure, when the pair of protrusions are inserted into the insertion holes respectively, a leg portion of each of the pair of protrusions, the leg portion being positioned closer to the base body side than the wedge portion, may be configured to push and widen the insertion hole.

Further, in the electric circuit switching device according to the present disclosure, the piston may be disposed in the tubular space in a mode of being restricted in rotation about an axial direction thereof.

### Advantageous Effects of Invention

According to an electric circuit switching device of the present disclosure, it is possible to shorten the time required for switching a predetermined electric circuit from an interrupted state to a conductive state.

### BRIEF DESCRIPTION OF DRAWINGS

FIG. 1 is a perspective view of a switching device according to a first embodiment.

FIG. 2 is a vertical cross-sectional view illustrating a state before actuation of the switching device according to the first embodiment.

FIG. 3 is a view for describing a tubular space in the switching device according to the first embodiment.

FIG. 4 is a plan view of a pair of first conductor pieces according to the first embodiment.

FIG. 5 is a view for describing a conductor component according to the first embodiment.

FIG. 6 is a vertical cross-sectional view illustrating the switching device according to the first embodiment after actuation.

FIG. 7 is a vertical cross-sectional view illustrating a state before actuation of a switching device according to a second embodiment.

FIG. 8 is a vertical cross-sectional view illustrating a state after actuation of the switching device according to the second embodiment.

FIG. 9 is a vertical cross-sectional view before actuation of a switching device according to a third embodiment.

FIG. 10 is a perspective view of a switching device according to a fourth embodiment.

FIG. 11 is a vertical cross-sectional view before actuation of the switching device according to the fourth embodiment.

FIG. 12 is a view for describing a conductor component according to the fourth embodiment.

### DESCRIPTION OF EMBODIMENTS

An electric circuit switching device according to embodiments of the present disclosure will be described below with reference to the drawings. Note that each of configurations, combinations thereof, and the like in the embodiments are an example, and various additions, omissions, substitutions, and other changes of the configurations may be made as appropriate without departing from the spirit of the present disclosure. The present disclosure is not limited by the embodiments and is limited only by the claims.

An electric circuit switching device according to an embodiment of the present disclosure is a device installed in an electric device (or an electric facility) and configured to rapidly switch a conductive state and an interrupted state (also referred to as a “non-conductive state”) of an electric circuit. For example, the electric circuit switching device according to the embodiment can be used as a short-circuiting device that, when an abnormality occurs in the electric device in which it is installed, short-circuits a predetermined electric circuit by urgently switching the electric circuit from an “interrupted state” of the electric circuit being interrupted to a “conductive state” of the electric circuit being conductive. As another usage example of the electric circuit switching device according to an embodiment, the electric circuit switching device can be used as a switching device that interrupts an electric circuit in a conductive state and makes another electric circuit in an interrupted state be conductive. Note that, in this specification, a “conductive state” refers to a state in which an electric circuit is electrically connected, allowing a current to run therethrough, and “interrupted” refers to a state in which an electric circuit is not electrically connected, not allowing a current to run therethrough.

### FIRST EMBODIMENT

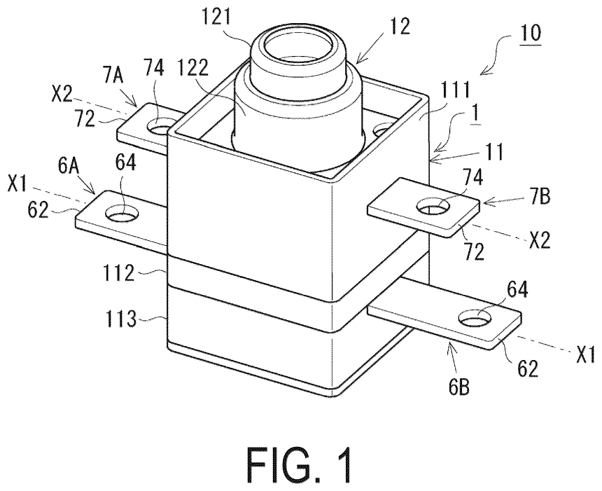

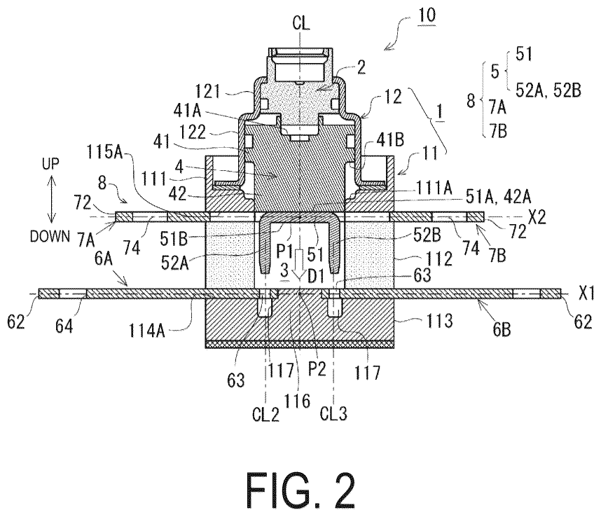

S FIG. 1 is a perspective view of an electric circuit switching device (hereinafter simply referred to as “switching device”) 10 according to a first embodiment. In the present specification, a cross section in a vertical direction illustrated in FIG. 1 is referred to as a vertical cross section of the switching device 10, and a cross section in a direction orthogonal to the vertical cross section is referred to as a transverse cross section of the switching device 10. FIG. 2 is a vertical cross-sectional view illustrating 10 a state before actuation of the switching device 10 according to the first embodiment.

The switching device 10 includes a housing 1, an igniter 2 provided in the housing 1, a tubular space formed in the housing 1, a piston 4 and a projectile 5 15 accommodated in the tubular space 3, a pair of first conductor pieces 6, 6 provided in the housing 1, a pair of second conductor pieces 7A, 7B provided in the housing 1, and the like. Note that, in the switching device 10, a state before the igniter 2 is actuated may be referred to as an “initial state.”

### Housing

The housing 1 is an outer shell member that accommodates various components and elements constituting the switching device 10. The housing 1 is configured to include a housing body 11 and a top holder 12 attached to an upper portion of the housing body 11. The top holder 12 is made of metal, for example, and is an outer shell member having a stepped cylindrical shape as illustrated in FIG. 1. The top holder 12 is configured to include a small-diameter portion 121 and a large-diameter portion 122 continuous below the small-diameter portion 121. An upper end of the top holder 12 is an open end, and the igniter 2 is attached to an inner space side of the small-diameter portion 121, airtightly closing the open end. Note that, for 30 convenience, the igniter 2 is not illustrated in FIG. 1.

The housing body 11 is an outer shell member formed from an insulating member such as a synthetic resin, for example. For example, the housing body 11 may be formed from nylon, which is a type of polyamide synthetic resin. In the example 35 illustrated in FIG. 1 and FIG. 2, the housing body 11 is configured by combining a top housing 111, a middle housing 112, and a bottom housing 113, but is not particularly limited to this mode.

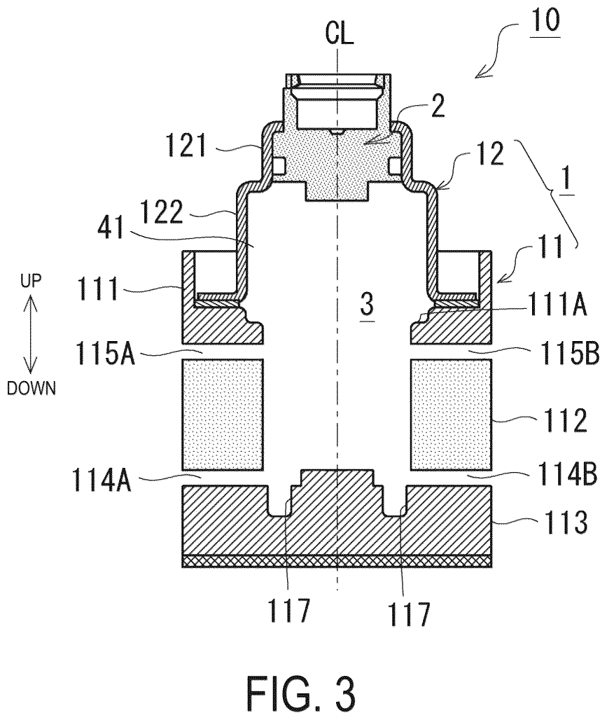

FIG. 3 is a view for describing the tubular space 3 formed in the housing 1 in the switching device 10 according to the first embodiment, and illustrates a vertical cross section of the switching device 10 before actuation with illustration of the piston 4 and the projectile 5 omitted for convenience. In FIG. 3, the pair of first conductor pieces 6A, 6B and the pair of second conductor pieces 7A, 7B are also not illustrated. As illustrated in FIG. 3, the tubular space 3 extending in one direction is formed in the housing 1. Reference sign CL illustrated in FIG. 3 denotes an axial line of the tubular space 3 extending in one direction in the housing 1. Further, in the present embodiment, the tubular space 3 extends in the vertical direction of the switching device 10 (housing 1). As illustrated in FIG. 2, the piston 4 and the projectile 5 are accommodated in the tubular space 3 formed in this manner.

Further, reference signs 114A, 114B illustrated in FIG. 3 denote first holding holes for inserting and holding the pair of first conductor pieces 6A, 6B. Reference signs 115A, 115B denote second holding holes for inserting and holding the pair of second conductor pieces 7A, 7B. The first holding holes 114A, 114B are formed as recessed portions formed between an upper surface of the bottom housing 113 and a lower surface of the middle housing 112, for example. Further, the second holding holes 115A, 115B are formed as recessed portions formed between an upper surface of the middle housing 112 and a lower surface of the top housing 111. The first holding holes 114A, 114B and the second holding holes 115A, 115B extend in a transverse cross-sectional direction of the switching device 10 (housing 1). Further, one end side of the first holding holes 114A, 114B communicates with the tubular space 3, and the other end side is open toward the outside of the housing 1. Similarly, one end side of the second holding holes 115A, 115B communicates with the tubular space 3, and the other end side is open toward the outside of the housing 1.

### Igniter

The igniter 2 is an ignition device that releases a combustion gas into the tubular space 3 upon actuation, and includes an ignition portion that accommodates an ignition charge in a cup body, for example. The igniter 2 can be formed by, for example, an electric igniter. The ignition charge accommodated in the ignition portion of the igniter 2 is not particularly limited and, for example, zirconium-potassium perchlorate (ZPP), zirconium-tungsten-potassium perchlorate (ZWPP), titanium hydride-potassium perchlorate (THPP), or lead tricinate may be adopted. Further, the igniter 2 may have an electro-conductive pin (not illustrated) connected to a connector of an external power supply, and may ignite the ignition charge by an actuating current supplied from the external power supply to the electro-conductive pin. This type of electric igniter is known and, for example, an electric igniter provided in an inflator of an airbag device can be suitably adopted. The igniter 2 is disposed with the ignition portion facing the inside of the tubular space 3. The igniter 2 releases the combustion gas generated by combustion of the ignition charge upon actuation into the tubular space 3.

### Projectile

The projectile 5 is formed by, for example, a metal piece having conductivity. As illustrated in FIG. 2, the projectile 5 is accommodated in the tubular space 3 of the housing 1. The projectile 5 is positioned at a predetermined first position P1 on the axial line CL of the tubular space 3 in an initial state before actuation of the igniter 2. As described in detail below, upon actuation of the igniter 2, the projectile 5 is projected in a predetermined projecting direction D1 along the axial line CL of the tubular space 3 by energy of the combustion gas released from the igniter 2 into the tubular space 3. In the example illustrated in FIG. 2, the projecting direction D1 is set to a downward direction along the axial line CL of the tubular space 3. Further, the projectile 5 may also be referred to as a “bullet.”

The projectile 5 is configured to include a base body 51 and a pair of protrusions 52A, 52B protruding downward (in the projecting direction D1) from this base body 51. The projectile 5 can be referred to as a so-called fork-type bullet.

### Piston

As illustrated in FIG. 2, in the initial state, the piston 4 is disposed in the tubular space 3, interposed between the igniter 2 and the projectile 5. Then, upon actuation of the igniter 2, the piston 4 is projected in the projecting direction D1 described above by the energy of the combustion gas released from the igniter 2 into the tubular space 3.

The piston 4 has a substantially cylindrical shape as a whole, and is formed by, for example, an insulating member such as a synthetic resin. The piston 4 in the present embodiment is configured to include, for example, a sliding portion 41 positioned on an upper end side and a rod portion 42 connected below the sliding portion 41. The sliding portion 41 of the piston 4 has a diameter substantially corresponding to an inner diameter of the large-diameter portion 122 of the top holder 12, and is guided along an inner wall surface of the large-diameter portion 122 when projected in the projecting direction D1 upon actuation of the igniter 2. This allows the piston 4 to move along the axial line CL of the tubular space 3. Note that the diameter of the sliding portion 41 of the piston 4 may be slightly small as compared with the inner diameter of the large-diameter portion 122. Further, a shape of the sliding portion 41 can be changed as appropriate and thus match a shape of the inner wall surface of the large-diameter portion 122.

Further, reference sign 41A denotes a depressed portion formed by a portion of an upper surface of the sliding portion 41 being depressed. In the initial state, part of the ignition portion of the igniter 2 is received in the depressed portion 41A of the piston 4. Therefore, the energy of the combustion gas released from the igniter 2 upon actuation can be efficiently received by the depressed portion 41A, and the energy can be efficiently utilized as a propulsive force for projection in the projecting direction D1.

When the piston 4 is projected in the projecting direction D1 upon actuation of the igniter 2A, the lower surface 41B of the sliding portion 41 of the piston 4 collides with a stopper portion 111A of the housing 1 (top housing 111), restricting further movement of the piston 4 in the projecting direction D1. However, the piston 4 is not limited to such a mode, and various modes can be adopted.

Further, a constricted portion having an outer circumferential surface recessed as compared with other locations is annularly formed in a circumferential direction of the sliding portion 41 at an axially intermediate portion of the sliding portion 41 of the piston 4. Annular packing (not illustrated) is fitted into this constricted portion. This annular packing is formed from, for example, rubber (silicone rubber, for example) or a synthetic resin, and functions to increase airtightness between an inner wall surface of the large-diameter portion 122 and the sliding portion 41.

The rod portion 42 of the piston 4 has, for example, a columnar rod shape having a small diameter as compared with that of the sliding portion 41. A lower surface (distal end surface) 42A of the rod portion 42 is positioned facing an upper surface 51A of the base body 51 of the projectile 5. Therefore, when the piston 4 is projected in the projecting direction D1 upon actuation of the igniter 2, the lower surface 42A of the rod portion 42 presses the upper surface 51A of the base body 51 of the projectile 5. This makes it possible to transmit, upon actuation of the igniter 2, the energy of the combustion gas to the projectile 5 via the piston 4, and project the projectile 5 in the projecting direction D1.

Note that, in the present embodiment, the piston 4 and the projectile 5 are integrally fixed (joined) to each other. More specifically, the lower surface 42A of the rod portion 42 of the piston 4 is bonded to the upper surface 51A of the base body 51 of the projectile 5, whereby the piston 4 and the projectile 5 are integrated. Note that the specific method of integrating the piston 4 and the projectile 5 is not particularly limited. For example, a screw may be used, or the piston 4 and the projectile 5 may be integrated by press-fitting.

### First Conductor Pieces

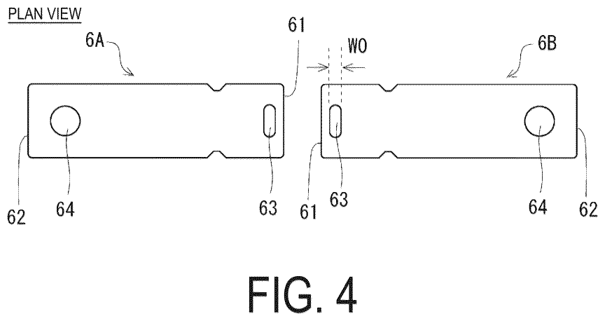

FIG. 4 is a plan view of the pair of first conductor pieces 6A, 6B according to the first embodiment. The first conductor pieces 6A, 6B have substantially the same structure. As illustrated in FIG. 4, the pair of first conductor pieces 6A, 6B are conductors formed from rectangular metal plates. The pair of first conductor pieces 6A, 6B can be formed from a metal such as copper (Cu), for example. However, the pair of first conductor pieces 6A, 6B may be formed from a metal other than copper, or may be formed from an alloy of copper and another metal. Note that examples of metals other than copper that can be included in the pair of first conductor pieces 6A, 6B include manganese (Mn), nickel (Ni), and platinum (Pt).

The pair of first conductor pieces 6A, 6B are components constituting the switching device 10, and are conductor pieces for forming, in cooperation with each other, part of a predetermined first electric circuit in an electric device to which the switching device 10 is applied. The pair of first conductor pieces 6A, 6B are also referred to as bus bars. The first electric circuit is formed including the pair of first conductor pieces 6A, 6B and a circuit component in another electric device.

The pair of first conductor pieces 6A, 6B include insertion holes 63 into which the protrusions 52A, 52B of the projectile 5 can be inserted on an inner end 61 side, and connection holes 64 on an outer end 62 side. A shape of the insertion hole 63 is not particularly limited, but in the example illustrated in FIG. 4, is formed as an elongated hole extending in a width direction of the first conductor pieces 6A, 6B. Reference sign WO illustrated in FIG. 4 denotes an opening width of the connection hole 64 in a minor axis direction. Further, the connection holes 64 are used to connect with other conductors (lead wires, for example) formed in the first electric circuit. The pair of first conductor pieces 6A, 6B are held inserted into the pair of first holding holes 114A, 114B of the housing 1. At this time, as illustrated in FIG. 2, the first conductor pieces 6A, 6B are disposed in the pair of first holding holes 114A, 114B with each inner end 61 side inserted into the tubular space 3 and each outer end 62 side exposed to the outside of the housing 1.

As illustrated in FIG. 2, the bottom housing 113 includes a support portion 116 for supporting the inner end 61 sides of the first conductor pieces 6A, 6B. As illustrated in FIG. 2, the pair of first conductor pieces 6A, 6B in the present embodiment are held, in a spaced apart state, in the pair of first holding holes 114A, 114B in the housing 1. The first holding holes 114A, 114B in the housing 1 and the pair of first holding holes 114A, 114B supported by the support portion 116 are, as illustrated in FIG. 2, incorporated in the housing 1 in postures extending in a direction orthogonal to the axial line CL of the tubular space 3. Further, as illustrated in FIG. 2, in the initial state before actuation of the igniter 2, the pair of first conductor pieces 6A, 6B are positioned at a predetermined second position P2. The second position P2 is defined as a position farther on the projecting direction D1 side than the first position P1 where the projectile 5 is positioned. Further, a pair of recessed portions 117 are formed in a bottom portion of the bottom housing 113, facing the tubular space 3. The pair of recessed portions 117 are recessed portions for receiving distal end sides of the protrusions 52A, 52B of the projectile 5 that is projected upon actuation of the igniter 2. The recessed portions 117 are formed in a shape of an elongated hole having a transverse cross section that is one size larger than a transverse cross section of the protrusions 52A, 52B in order to accommodate the protrusions 52A, 52B of the projectile 5.

The pair of first conductor pieces 6A, 6B configured as described above are spaced apart before actuation of the igniter 2 as illustrated in FIG. 2, and thus the first electric circuit is maintained in an interrupted state. On the other hand, although the operation of the switching device 10 will be described below, when the igniter 2 is actuated, the pair of first conductor pieces 6A, 6B are electrically connected to each other via the projectile 5, and the first electric circuit is switched from the interrupted state to the conductive state. Accordingly, in the present embodiment, the projectile 5 can be said to also function as a circuit component constituting the first electric circuit. Note that reference sign X1 illustrated in FIG. 1 is an array axis of the pair of first conductor pieces 6A, 6B in a state of being incorporated in the housing 1.

### Second Conductor Pieces

Next, the pair of second conductor pieces 7A, 7B in the present embodiment will be described. The pair of second conductor pieces 7A, 7B are components constituting the switching device 10, and are conductor pieces for forming, in cooperation with each other, part of a predetermined second electric circuit in an electric device to which the switching device 10 is applied. The pair of second conductor pieces 7A, 7B are also referred as bus bars. The second electric circuit is formed including the pair of second conductor pieces 7A, 7B and a circuit component in another electric device.

In the present embodiment, in a state before actuation of the igniter 2, that is, in the initial state, the pair of second conductor pieces 7A, 7B are electrically connected by the projectile 5 (refer to FIG. 2). Specifically, a conductor component 8 in which the pair of second conductor pieces 7A, 7B and the projectile 5 are integrated is provided in the housing 1.

FIG. S is a view for describing the conductor component 8 according to the first embodiment, and illustrates a plan view (top view), a cross-sectional view, and a side view of the conductor component 8. The cross-sectional view illustrates an A-A cross section in a major axis direction of the conductor component 8. Further, the side view illustrates a state in which the conductor component 8 is viewed from a direction of an arrow B.

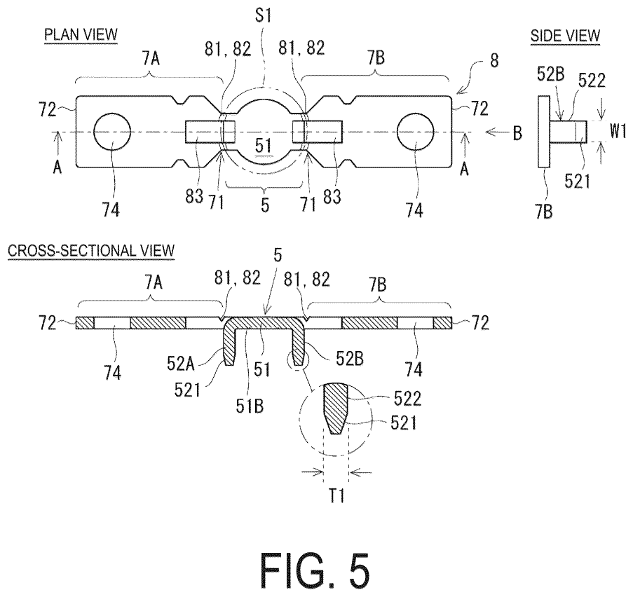

As illustrated in FIG. 5, the conductor component 8 is a metal body obtained by interposing the projectile 5 between the pair of second conductor pieces 7A, 7B, and integrally connecting these. In the conductor component 8, the second conductor piece 7A, the projectile 5, and the second conductor piece 7B are arrayed in a straight line. A material of the conductor component 8 is not particularly limited as long as the material is a conductor, and the material used for the first conductor pieces 6A, 6B described above (for example, copper or the like) can be suitably adopted. Note that reference sign X2 illustrated in FIG. 1 denotes an array axis of the pair of second conductor pieces 7A, 7B in a state of being incorporated in the housing 1. In the present embodiment, the array axis X2 of the pair of second conductor pieces 7A, 7B is parallel to the array axis X1 of the pair of first conductor pieces 6A, 6B. Further, the array axis X2 of the pair of second conductor pieces 7A, 7B is set in alignment with an axial line of a longitudinal direction of the conductor component 8. Further, an A-A cross section of the conductor component 8 is a cross section extending through the axial line of the longitudinal direction of the conductor component 8.

Next, details of each component of the conductor component 8 will be described. The pair of second conductor pieces 7A, 7B are formed as conductor pieces extending in one direction, and the inner end 71 sides thereof are integrally connected to the base body 51 of the projectile 5. Connection holes 74 similar to those of the first conductor pieces 6A, 6B described above are formed on outer end 72 sides of the second conductor pieces 7A, 7B. The connection holes 74 are used to connect with other conductors (lead wires, for example) formed in the second electric circuit.

Reference sign 81 denotes a connection portion at which each of the second conductor pieces 7A, 7B and the base body 51 of the projectile 5 are connected. A notch 82 is formed in the connection portion 81 of the conductor component 8 by beveling a member surface. With the notch 82 provided in this way, the connection portion 81 has a thin plate thickness as compared with that of other portions and, as a result, is weak as compared with other portions. Note that the notch 82 may be provided on any one of an upper surface or a lower surface of the conductor component 8, or may be provided on both. Of course, a shape of the notch 82 is a V shape, a U shape, or the like, and is not particularly limited.

In the projectile 5, the pair of protrusions 52A, 52B protrude downward from the lower surface 51B of the base body 51. As illustrated in the cross-sectional view and the side view of FIG. 5, the pair of protrusions 52A, 52B have a blade shape and substantially correspond to the insertion holes 63 having an elongated hole shape formed in the pair of first conductor pieces 6A, 6B. The pair of protrusions 52A, 52B in the projectile 5 configured as described above are vertically erected from the lower surface 51B of the base body 51 while spaced apart from each other by a predetermined interval. Further, a wedge portion 521 having a wedge shape is formed on a distal end side (lower end side) of each of the protrusions 52A, 52B. The wedge shape is a shape tapered toward the distal end side. Further, reference sign 522 denotes leg portions of the protrusions 52A, 52B which are positioned closer to the base body 51 than the wedge portion 521. A width dimension WI of the leg portions 522 of the protrusion portions 52A, 52B is large as compared with a thickness dimension T1.

The conductor component 8 configured as described above is incorporated into the housing 1 with part of the inner end 71 sides of the second conductor pieces 7A, 7B as well as the projectile 5 being accommodated in the tubular space 3, and the outer end 62 sides of the second conductor pieces 7A, 7B being exposed to the outside of the housing 1. At this time, the pair of second conductor pieces 7A, 7B of the conductor component 8 are held in the pair of second holding holes 115A, 115B of the housing 1, respectively. Further, as illustrated in FIG. 2, in a state in which the conductor component 8 is incorporated in the housing 1, the base body 51 of the projectile 5 and the second conductor pieces 7A, 7B connected to the base body 51 are disposed in postures extending in a direction orthogonal to the axial line CL of the tubular space 3. At this time, the position of the axial line CL where the pair of second conductor pieces 7A, 7B are disposed is the same first position P1 as the base body 51 of the projectile 5. Further, when the conductor component 8 is incorporated into the housing 1, the projectile 5 may be positioned with a center of the base body 51 of the projectile 5 passing through the axial line CL of the tubular space 3. Furthermore, in the initial state illustrated in FIG. 2, distal end positions (lower end positions) of the protrusions 52A, 52B of the projectile 5 are disposed above the pair of first conductor pieces 6A, 6B, and the projectile 5 is in a state (non-contact state) away from the pair of first conductor pieces 6A, 6B.

Further, reference signs CL2, CL3 illustrated in FIG. 2 denote axial lines of the protrusions 52A, 52B of the projectile 5. The axial lines CL2, CL3 of the protrusions 52A, 52B are parallel to the axial line CL of the tubular space 3, and a positional relationship thereof is defined, making center axes of the insertion holes 63 and the recessed portions 117 of the pair of first conductor pieces 6A, 6B be positioned on the axial lines CL2, CL3.

Further, in the conductor component 8, upon actuation of the igniter 2, the connection portion 81 is pushed and cut by the lower surface 42A of the rod portion 42 of the piston 4, and the projectile 5 is cut off. Reference sign SI in the drawing denotes a planned break line indicating a position where the conductor component 8 is pushed and cut by the rod portion 42 of the piston 4 upon actuation of the igniter 2. In the drawing, the planned break line SI indicated by a two dot chain line coincides with a contour position of an outer circumferential surface of the rod portion 42 of the piston 4 disposed in an upper portion of the base body 51 of the projectile 5 in a state in which the conductor component 8 is incorporated into the housing 1.

Further, as illustrated in FIG. 5, the conductor component 8 is provided with a pair of cutout holes 83 extending across the second conductor pieces 7A, 7B and the projectile 5. In other words, the pair of cutout holes 83 are disposed across the planned break line SI of the conductor component 8. With this configuration, a cut-off area when the projectile 5 is cut off from the conductor component 8 (second conductor pieces 7A, 7B) by the piston 4 (rod portion 42) upon actuation of the igniter 2 can be reduced, making smooth cut-off of the projectile 5 possible.

### Operation

Next, operation of the switching device 10 will be described. Before actuation, the switching device 10 is in the initial state illustrated in FIG. 2 as described above. In the initial state illustrated in FIG. 2, the pair of first conductor pieces 6A, 6B are spaced apart, and thus the first electric circuit partially formed by the pair of first conductor pieces 6A, 6B is maintained in an interrupted state. On the other hand, in the initial state described above, the pair of second conductor pieces 7A, 7B are electrically connected to each other via the projectile 5, and thus the second electric circuit is in a conductive state.

For example, when an abnormality occurs in an electric device to which the switching device 10 is applied, the switching device 10 is actuated to protect the electric device, and urgently switches the second electric circuit from the conductive state to an interrupted state and the first electric circuit from the interrupted state to a conductive state.

A target to which the switching device 10 is applied is not particularly limited. For example, the switching device 10 may be mounted on a vehicle such as an automobile. For example, when a control unit of a battery of a vehicle fails, the second electric circuit may be switched from the conductive state to the non-conductive state to interrupt a power supply from the battery to the outside, thereby suppressing failure of an external component due to the excessive current, and the first electric circuit may be switched from the non-conductive state to the conductive state to release a charge accumulated in the second electric circuit from the first electric circuit, thereby protecting the second electric circuit. As a matter of course, the application example of the switching device 10 described above is merely an example, and the switching device 10 may be applied to an electric device or an electric facility other than the vehicle.

Further, the switching device 10 according to the present embodiment may further include an abnormality detection sensor (not illustrated) configured to detect an abnormal state of the electric device in which the switching device 10 is installed, and a control unit (not illustrated) configured to control actuation of the igniter 2. The abnormality detection sensor may detect an abnormal state such as an excessive current on the basis of, for example, a current flowing through an electric circuit to be protected in the electric device. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle.

The control unit of the switching device 10 is a computer capable of performing a predetermined function by executing a predetermined control program, for example. The predetermined function of the control unit may be realized by corresponding hardware. For example, when excessive current flows through a circuit that is to be protected in an electric device in which the switching device 10 is installed, this excessive current is detected by the abnormality detection sensor.

Abnormality information regarding the detected abnormal current is passed from the abnormality detection sensor to the control unit. For example, the control unit is energized from an external power supply (not illustrated) connected to electro-conductive pins of the igniter 2 and actuates the igniter 2 on the basis of the current value detected by the abnormality detection sensor. Here, the excessive current may be defined by a current value that exceeds a predetermined threshold value set for protection of the electric circuit to be protected. Note that the abnormality detection sensor and the control unit described above need not be included in the components of the switching device 10, and may be included in a device separate from the switching device 10, for example. Further, the abnormality detection sensor and the control unit described above are not essential components of the switching device 10.

When the igniter 2 of the switching device 10 is actuated, the combustion gas is released from the igniter 2 into the tubular space 3. Then, the piston 4 receiving the energy (pressure) of the combustion gas released from the igniter 2 at the depressed portion 41A of the sliding portion 41 is projected in the projecting direction D1 (downward) in the tubular space 3 by using the energy of the combustion gas as a propulsive force. In the initial state, the projectile 5 of the conductor component 8 is disposed downward of the rod portion 42 of the piston 4, and the contour position of the lower surface 42A of the rod portion 42 is positioned at the connection portions 81 positioned at boundary portions between the projectile 5 and the second conductor pieces 7A, 7B of the conductor component 8. Therefore, upon actuation of the igniter 2, the piston 4 is vigorously pushed down in the projecting direction D1, separating the projectile 5 from the second conductor pieces 7A, 7B at the connection portions 81. Then, the projectile 5 positioned downward of the rod portion 42 of the piston 4 is projected together with the rod portion 42 in the projecting direction D1.

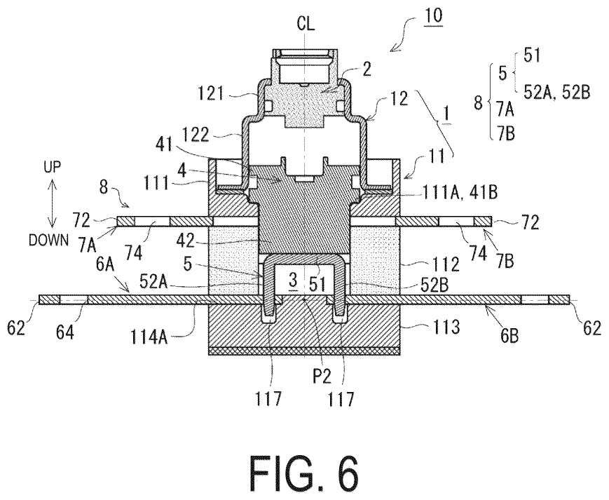

FIG. 6 is a vertical cross-sectional view illustrating the switching device 10 according to the first embodiment after actuation. As described above, the projectile 5 is separated from the second conductor pieces 7A, 7B via the piston 4 by the energy of the combustion gas released from the igniter 2, electrically interrupting the pair of second conductor pieces 7A, 7B. As a result, the second electric circuit partially formed by the pair of second conductor pieces 7A, 7B can be instantaneously switched from the conductive state to the interrupted state.

The projectile 5 projected together with the piston 4 in the projecting direction D1 along the axial line CL in the tubular space 3 is hung between the pair of first conductor pieces 6A, 6B positioned at the downward second position P2, and comes into contact with the pair of first conductor pieces 6A, 6B. More specifically, as illustrated in FIG. 6, after the pair of protrusions 52A, 52B of the projectile 5 are respectively inserted into the insertion holes 63 of the pair of first conductor pieces 6A, 6B, the distal end sides of the protrusions 52A, 52B are received in the recessed portions 117 of the housing 1. In the present embodiment, when the protrusions 52A, 52B of the projectile 5 are respectively inserted into the insertion holes 63 of the first conductor pieces 6A, 6B, the protrusions 52A, 52B come into contact with edge portions of the insertion holes 63. This makes it possible to instantaneously switch the first electric circuit from the interrupted state to the conductive state. Note that, although the projectile 5 according to the present embodiment is provided with the pair of protrusions 52A, 52B on the base body 51, needless to say, three or more protrusions may be provided. That is, the projectile 5 in the present embodiment can include at least one pair of protrusions. In a case in which three or more protrusions are provided to the base body 51 of the projectile 5, the insertion holes 63 can also be provided on the first conductor pieces 6A, 6B side in a quantity corresponding to that of the protrusions.

### Effects

As described above, the switching device 10 according to the first embodiment projects the projectile 5 having conductivity by utilizing the energy of the combustion gas generated by the ignition of the ignition charge in the igniter 2 as the energy source for actuating the switching device 10, and switches the electric circuit from the conductive state to the interrupted state or from the interrupted state to the conductive state by the projectile 5. By using a pyro-drive in which pyrotechnics are utilized as an actuation source of the switching device 10, it is possible to shorten the time required for switching the electric circuit as compared with, for example, an electromagnetic relay in the related art.

Further, the switching device 10 according to the first embodiment adopts the projectile 5 having a so-called fork shape. This makes it possible to incorporate the protrusions 52A, 52B into the tubular space 3 of the housing 1 in a state in which the distal ends thereof are closer to the pair of first conductor pieces 6A, 6B than the position of the base body 51 of the projectile 5. Accordingly, a distance between the projectile 5 and the first conductor pieces 6A, 6B in the initial state before the igniter 2 is actuated can be suitably reduced, making it possible to further reduce the time required for switching the electric circuit. Note that arranging the first conductor pieces 6A, 6B and the second conductor pieces 7A, 7B held by the housing 1 so close to each other may be difficult due to a structural aspect or some other restriction. Thus, according to the switching device 10 according to the present embodiment, even in a case in which setting the first position P1 where the conductor component 8, in which the pair of second conductor pieces 6A, 6B and the projectile 5 are integrated, is initially positioned and the second position P2 where the pair of first conductor pieces 6A, 6B are initially disposed at positions close to each other is difficult, it is possible to freely adjust lengths of the protrusions 52A, 52B of the projectile 5 and position the distal ends of the protrusions 52A, 52B farther in the projecting direction D1 than the first position P1. This makes it possible to switch the electric circuit more quickly.

Further, in the switching device 10 according to the first embodiment, the conductor component 8, in which the base body 51 of the projectile 5 is interposed between the pair of second conductor pieces 7A, 7B and these are integrally connected to each other, is incorporated into the housing 1, and the base body 51 is separated from each of the pair of second conductor pieces 7A, 7B by the energy of the combustion gas released from the igniter 2 upon actuation of the igniter 2. According to this configuration, it is possible to smoothly switch the second electric circuit partially formed by the pair of second conductor pieces 7A, 7B from the conductive state to the interrupted state upon actuation of the igniter 2. Further, in the present embodiment, the protrusions 52A, 52B of the projectile 5 projected upon actuation of the igniter 2 are inserted into the insertion holes 63, and the protrusions 52A, 52B are reliably brought into contact with the edge portions of the insertion holes 63, making it possible to reliably switch the first electric circuit to the conductive state. In particular, with the wedge portion 521 having a wedge shape formed on the distal end side of each of the protrusions 52A, 52B of the projectile 5, it is possible to smoothly insert each of the protrusions 52A, 52B into the insertion holes 63 when the projectile 5 is projected.

Here, the thickness dimension T1 of the leg portions 522 of the protrusions 52A, 52B may be greater than the opening width WO of the insertion holes 63 of the first conductor pieces 6A, 6B. According to this configuration, it is possible to insert the leg portions 522 into the insertion holes 63 while the insertion holes 63 are being widened by the leg portions 522 of the protrusions 52A, 52B when the projectile 5 is projected. This makes it possible to maintain a more reliable contact state between each of the protrusions 52A, 52B and the edge portions of the insertion holes 63.

Furthermore, in the present embodiment, a structure in which the piston 4 and the projectile 5 in the switching device 10 are integrally joined is adopted. Accordingly, when the projectile 5 moves in the projecting direction D1 upon actuation of the switching device 10, it is possible to suppress rotation and axial displacement of the projectile 5. That is, the projectile 5 can be lowered along the axial line CL of the tubular space 3 in a state in which the posture of the projectile 5 is stabilized. Further, by fixing the projectile 5 to the piston 4, it is possible to prevent returning of the projectile 5 in a direction opposite to the projecting direction D1, that is, toward the first position P1 side, due to an impact when the wedge portions 521 of the protrusion 52A, 52B of the projectile 5 are received by the recessed portions 117 of the housing 1. Further, when the structure in which the projectile 5 is integrally fixed to the piston 4 as described above is combined with a mode in which the protrusions 52A, 52B of the projectile 5 are inserted into the insertion holes 63 formed in the first conductor pieces 6A, 6B as in the present embodiment, the effects become more remarkable.

Further, in a case in which the structure obtained by integrally joining the piston 4 and the projectile 5 to each other is adopted, the piston 4 may be disposed in the tubular space 3 in a mode in which rotation of the piston 4 about the axial direction is restricted. According to this configuration, the rotation of the projectile 5 projected upon actuation of the switching device 10 can be suppressed even more effectively. Examples of structures for restricting the rotation of the piston 4 about the axial direction include making an outer peripheral shape of the piston 4 (sliding portion 41) and an inner wall surface shape (inner wall surface of the large-diameter portion 122 of the top holder 12) on the housing 1 side where the piston 4 (sliding portion 41) slides into polygonal shapes.

### SECOND EMBODIMENT

Next, a switching device 10A according to a second embodiment will be described. Here, description will be made with a focus on the differences from the first embodiment. Configurations common to those of the switching device 10 according to the first embodiment will be denoted using the same references signs, and detailed description thereof will be omitted.

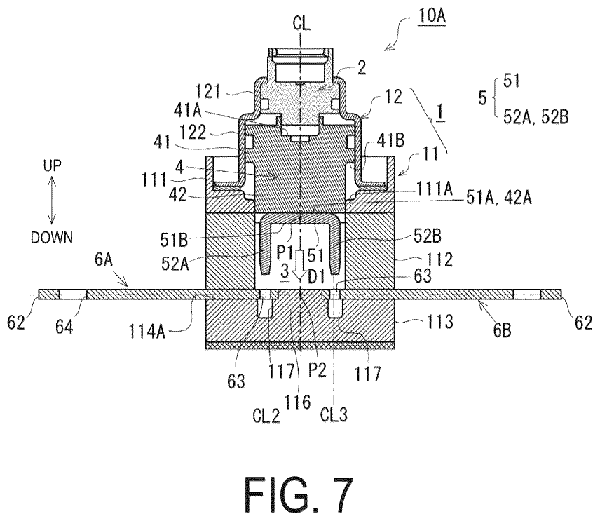

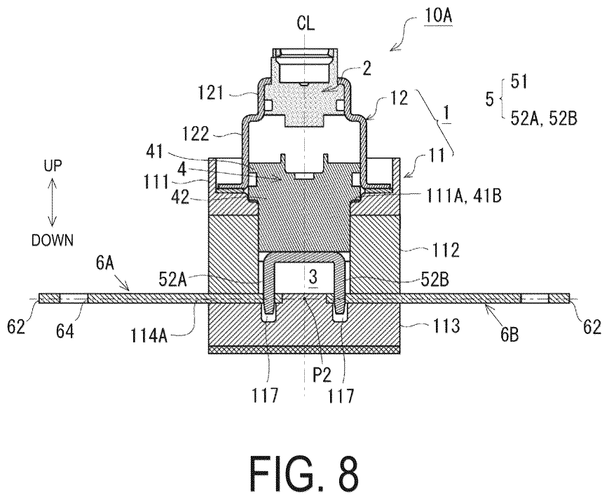

FIG. 7 is a vertical cross-sectional view illustrating a state before actuation of the switching device 10A according to the second embodiment. FIG. 8 is a vertical cross-sectional view illustrating a state after actuation of the switching device 10A according to the second embodiment. The switching device 10A according to the present embodiment differs from the switching device 10 according to the first embodiment in that the pair of second conductor pieces 7A, 7B are not provided in the housing 1. Accordingly, the switching device 10A differs from the switching device 10 according to the first embodiment in that the second holding holes 115A, 115B are not formed in the housing 1 and the projectile 5 is singly disposed in the tubular space 3 instead of the conductor component 8. The switching device 10A configured as described above is used as a device that instantaneously switches the first electric circuit partially formed by the pair of first conductor pieces 6A, 6B from an interrupted state to a conductive state. For example, the first electric circuit may be configured as a short-circuiting circuit that short-circuits a current by switching from an interrupted state to a conductive state for the purpose of releasing an electric charge accumulated in a circuit or a component to be protected. Further, the first electric circuit may be configured as, for example, a circuit for bypassing a failed location when any of the circuits constituting the electric facility, such as a semiconductor element or a battery cell, fails.

As illustrated in FIG. 7, the tubular space 3 formed inside the housing 1 of the switching device 10A accommodates the piston 4 and the projectile 5. As described in the first embodiment, the projectile 5 is configured to include the base body 51 and the protrusions 52A, 52B, and the base body 51 is positioned at the first position P1 in the initial state before actuation of the switching device 10A. Of course, in a state in which the base body 51 of the projectile 5 is positioned at the first position P1, the projectile 5 is held away from the pair of first conductor pieces 6A, 6B.

The projectile 5 may be held at the first position P1 by, for example, temporarily fixing the base body 51 to an inner wall surface of the housing 1 defining the tubular space 3. For example, the base body 51 may be press-fitted into the inner wall surface of the housing 1 defining the tubular space 3, thereby suppressing a downward fall of the projectile 5 before actuation of the switching device 10A, and the projectile 5 may be projected in the projecting direction D1 by the energy of the combustion gas released from the igniter 2 upon actuation of the switching device 10A.

In the switching device 10A configured as described above, the relationship between the projectile 5 and the piston 4 is the same as that in the first embodiment. That is, in the initial state before actuation of the switching device 10A, the lower surface (distal end surface) 42A of the rod portion 42 of the piston 4 is positioned facing the upper surface 51A of the base body 51 of the projectile 5. Further, in the present embodiment as well, the projectile 5 and the piston 4 are integrally fixed. Therefore, when the igniter 2 is actuated, the piston 4 and the projectile 5 are projected integrally in the projecting direction D1 in the tubular space 3 by the energy of the combustion gas released from the igniter 2 into the tubular space 3. As a result, the protrusions 52A, 52B of the projectile 5 are inserted into the insertion holes 63 of the pair of first conductor pieces 6A, 6B and come into contact with the edge portions of the insertion holes 63, thereby quickly switching the first electric circuit from the interrupted state to the conductive state.

### THIRD EMBODIMENT

Next, a switching device 10B according to a third embodiment will be described. Here, description will be made with a focus on the differences from the second embodiment. Configurations common to those of the switching device 10A according to the second embodiment will be denoted using the same references signs, and detailed description thereof will be omitted.

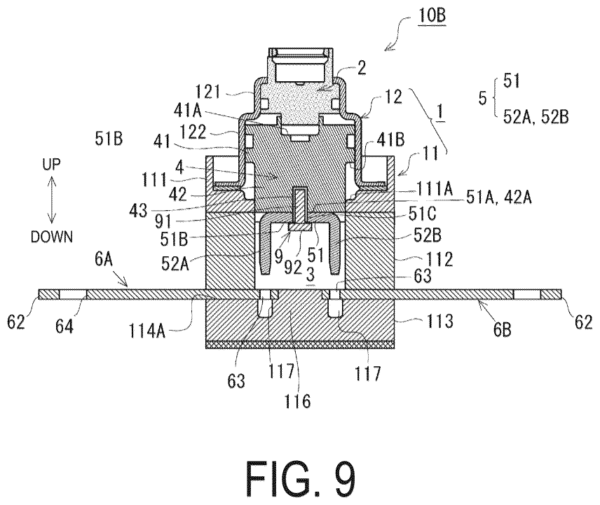

FIG. 9 is a vertical cross-sectional view before actuation of the switching device 10B according to the third embodiment. The switching device 10B differs from the switching device 10A in which the piston 4 and the projectile 5 are integrally fixed by bonding in that these are integrally fixed by a screw 9, but has the same structure as the that of switching device 10A in other respects. The screw 9 includes a shaft portion 91 with threads formed on an outer circumferential surface thereof, and a head portion 92 connected to an end portion of the shaft portion 91. In the present embodiment, a screw hole 51C into which the shaft portion 91 of the screw 9 is inserted is formed in the base body 51 of the projectile 5. Further, a screw hole 43 into which the shaft portion 91 is inserted is provided in the lower surface 42A of the rod portion 42 of the piston 4. The screw hole 43 of the rod portion 42 is formed as a recessed portion that opens to the lower surface 42A, and threads that can be screwed with the threads of the shaft portion 91 are formed on an inner circumferential surface thereof. In such a mode as well, the same effects as those of the switching device 10A according to the second embodiment are achieved. Of course, the integral structure of the piston 4 and the projectile 5 via the screw 9 can be applied to the switching device 10 according to the first embodiment.

### FOURTH EMBODIMENT

Next, a switching device 10C according to a fourth embodiment will be described. Here, description will be made with a focus on the differences from the first embodiment. Configurations common to those of the switching device 10 according to the first embodiment will be denoted using the same references signs, and detailed description thereof will be omitted.

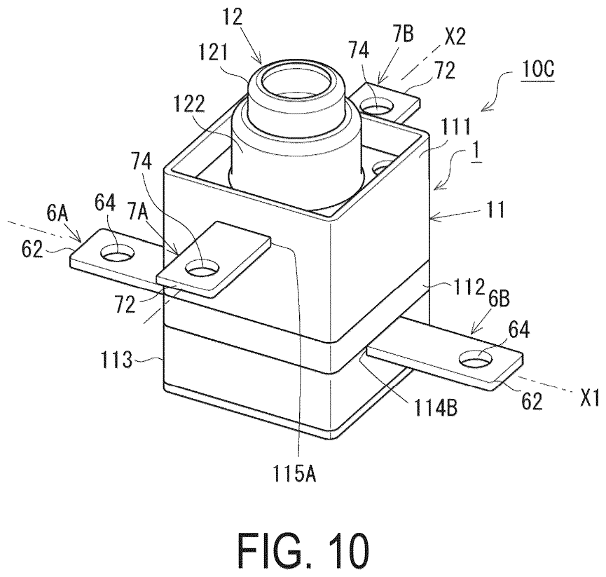

FIG. 10 is a perspective view of the switching device 10C according to the fourth embodiment. The switching device 10C according to the fourth embodiment is a mode obtained by modifying the switching device 10 according to the first embodiment, and differs from the switching device 10 according to the first embodiment in that, as illustrated in FIG. 10, the array axis X1 of the pair of first conductor pieces 6A, 6B and the array axis X2 of the pair of second conductor pieces 7A, 7B are orthogonal to each other in a state in of incorporation in the housing 1. In the present embodiment as well, the pair of second conductor pieces 7A, 7B are held inserted into the second holding holes 115A, 115B in the housing 1, and the second holding holes 115A, 115B are formed in the wall surface of the housing 1 having a rectangular shape, in a direction orthogonal to the wall surface in which the first holding holes 114A, 114B holding the pair of first conductor pieces 6A, 6B are provided (refer to FIG. 10). Note that, in FIG. 10, the first holding hole 114A and the second holding hole 115B are not illustrated for drawing purposes.

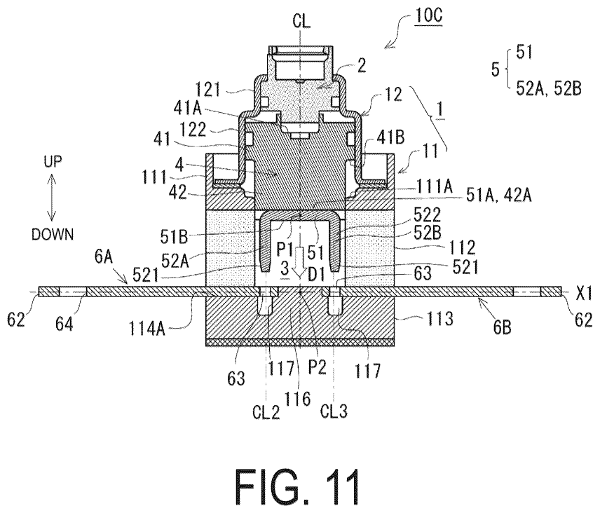

FIG. 11 is a vertical cross-sectional view before actuation of the switching device 10C according to the fourth embodiment. Specifically, FIG. 11 illustrates a cross section extending through the axial line CL of the tubular space 3 and the array axis X1 of the pair of first conductor pieces 6A, 6B in the switching device 10C.

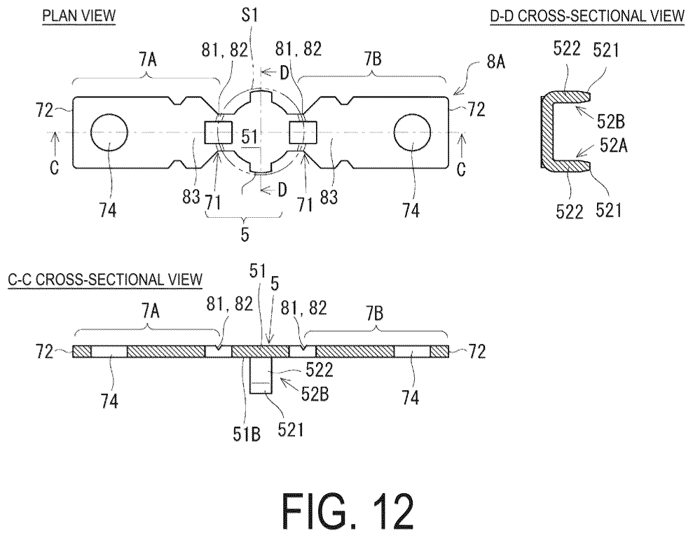

FIG. 12 is a view for describing a conductor component 8A according to the fourth embodiment. FIG. 12 illustrates a plane (upper surface) of the conductor component 8A, a C-C cross section in a major axis direction, and a D-D cross section in a minor axis cross section. As with the conductor component 8 of the first embodiment, the conductor component 8A of the present embodiment is also formed as a member in which the second conductor piece 7A, the projectile 5, and the second conductor piece 7B are integrally connected and thus arrayed in a straight line. In the conductor component 8A, configurations common to those of the conductor component 8 according to the first embodiment are denoted by the same reference signs, and detailed descriptions thereof will be omitted.

The pair of second conductor pieces 7A, 7B, as in the first embodiment, are formed as conductor pieces extending in one direction, and the inner end 71 sides thereof are integrally connected to the base body 51 of the projectile 5. Further, the pair of second conductor pieces 7A, 7B, as in the first embodiment, are components constituting the switching device 10C, and form, in cooperation with each other, part of the predetermined second electric circuit in an electric device to which the switching device 10C is applied.

In the conductor component 8A according to the fourth embodiment as well, the pair of protrusions 52A, 52B protrude downward from the lower surface 51B of the base body 51. In the present embodiment, the array axis X2 of the pair of second conductor pieces 7A, 7B is set in a direction orthogonal to the array axis XI of the pair of first conductor pieces 6A, 6B. Thus, in the conductor component 8A, an array direction of the pair of protrusions 52A, 52B of the projectile 5 differs by 90° from an array direction of the pair of protrusions 52A, 52B of the conductor component 8. That is, in the conductor component 8 according to the first embodiment, the pair of protrusions 52A, 52B are disposed at an interval in the major axis direction, but in the conductor component 8A according to the fourth embodiment, the pair of protrusions 52A, 52B are disposed at an interval in the minor axis direction. In addition, in the conductor component 8A as well, the wedge portion 521 is formed on the distal end sides of the leg portions 522 of the pair of protrusions 52A, 52B.

In FIG. 11, the array axis X2 of the pair of second conductor pieces 7A, 7B extends in a direction orthogonal to the array axis X1 of the pair of first conductor pieces 6A, 6B, that is, in a depth direction of the drawing. Then, the array direction of the pair of protrusion 52A, 52B of the conductor component 8A is set parallel to the array axis X1 of the pair of first conductor pieces 6A, 6B.

Further, in the present embodiment as well, in the initial state illustrated in FIG. 11, the distal end positions (lower end positions) of the protrusions 52A, 52B of the projectile 5 are disposed above the pair of first conductor pieces 6A, 6B, and the projectile 5 is in a state (non-contact state) away from the pair of first conductor pieces 6A, 6B. Further, when the conductor component 8 is incorporated into the housing 1, the projectile 5 is positioned with the center of the base body 51 of the projectile 5 passing through the axial line CL of the tubular space 3. In the initial state illustrated in FIG. 11, the axial lines CL2, CL3 of the protrusions 52A, 52B are parallel to the axial line CL of the tubular space 3, and the positional relationship thereof is defined, making the center axes of the insertion holes 63 and the recessed portions 117 of the pair of first conductor pieces 6A, 6B be positioned on the axial lines CL2, CL3.

In the switching device 10C according to the fourth embodiment configured as described above as well, in the initial state illustrated in FIG. 11, the pair of first conductor pieces 6A, 6B are spaced apart, and thus the first electric circuit partially formed by the pair of first conductor pieces 6A, 6B is maintained in an interrupted state. On the other hand, in the initial state described above, the pair of second conductor pieces 7A, 7B are electrically connected to each other via the projectile 5, and thus the second electric circuit is in a conductive state. Further, in the switching device 10C as well, the lower surface 42A of the rod portion 42 of the piston 4 is bonded to the upper surface 51A of the base body 51 of the projectile 5, thereby integrally fixing the projectile 5 to the piston 4. Of course, a specific method of integrating the piston 4 and the projectile 5 is not particularly limited. For example, as described in FIG. 9, the piston 4 and the projectile 5 may be integrated by using the screw 9. In this case, as with the switching device 10B, a screw hole need only be formed in each of the base body 51 of the projectile 5 and the lower surface 42A of the rod portion 42 of the piston 4.

Operation details of the switching device 10C according to the fourth embodiment are the same as those of the switching device 10 according to the first embodiment. That is, when the igniter 2 is actuated, the piston 4 is vigorously pushed down in the projecting direction D1 by the energy (pressure) of the combustion gas released from the igniter 2. As a result, the projectile 5 is separated from the second conductor pieces 7A, 7B, electrically disconnecting the pair of second conductor pieces 7A, 7B from each other, and the projectile 5 is projected integrally with the piston 4 in the projecting direction D1. The projectile 5 projected in this manner is hung between the pair of first conductor pieces 6A, 6B positioned below and comes into contact with the pair of first conductor pieces 6A, 6B. That is, after the pair of protrusions 52A, 52B of the projectile 5 are respectively inserted into the insertion holes 63 of the pair of first conductor pieces 6A, 6B, the distal end sides of the protrusions 52A, 52B are received in the recessed portions 117 of the housing 1. At this time, the protrusions 52A, 52B of the projectile 5 come into contact with the edge portions of the insertion holes 63 in the first conductor pieces 6A, 6B, electrically connecting the pair of first conductor pieces 6A, 6B to each other via the projectile 5. In this way, with actuation of the switching device 10C, it is possible to instantaneously switch the first electric circuit from an interrupted state to a conductive state, and instantaneously switch the second electric circuit from a conductive state to an interrupted state.

While embodiments of the electric circuit switching device according to the present disclosure have been described above, each aspect disclosed in the present specification can be combined with any other feature disclosed in the present specification.

Further, in the electric circuit switching device according to the present disclosure, the mode of the projectile is not particularly limited.

### REFERENCE SIGNS LIST

1 Housing

2 Igniter

3 Tubular space

4 Piston

5 Projectile

6A, 6B Pair of first conductor pieces

7A, 7B Pair of second conductor pieces

8 Conductor component

10, 10A Electric circuit switching device

1. An electric circuit switching device configured to switch a predetermined first electric circuit from an interrupted state to a conductive state upon actuation, the electric circuit switching device comprising:
a housing;
an igniter provided in the housing and configured to release a combustion gas upon actuation;
a tubular space formed in the housing and extending in one direction;
a projectile having conductivity and positioned at a predetermined first position in the tubular space in an initial state before actuation of the igniter;
a piston fixed to the projectile and disposed in the tubular space interposedly between the igniter and the projectile, and configured to be projected in a predetermined projecting direction along the tubular space by energy of the combustion gas; and
a pair of first conductor pieces provided inserted, in a spaced apart state, into the tubular space at a position closer to the projecting direction side than the first position, and forming part of the first electric circuit in cooperation with each other, wherein
the projectile projected integrally with the piston upon actuation of the igniter comes into contact with each of the pair of first conductor pieces, switching the first electric circuit from the interrupted state to the conductive state.

2. The electric circuit switching device according to claim 1, the electric circuit switching device being configured to further switch a predetermined second electric circuit from a conductive state to an interrupted state upon actuation, the electric circuit switching device further comprising:
a pair of second conductor pieces provided inserted, in a spaced apart state, into the tubular space, and forming part of the second electric circuit in cooperation with each other, wherein
in the initial state, the pair of second conductor pieces are electrically connected to each other via the projectile, causing the second electric circuit to be in the conductive state, and
an electrical connection between the pair of second conductor pieces via the projectile is disconnected when the projectile is projected in the projecting direction, switching the second electric circuit from the conductive state to the interrupted state.

3. The electric circuit switching device according to claim 2, wherein
in the initial state, the projectile is interposed between the pair of second conductor pieces, the projectile being integrally connected with the pair of second conductor pieces, and
the projectile is separated from each of the pair of second conductor pieces by the energy of the combustion gas.

4. The electric circuit switching device according to claim 1, wherein
the projectile includes a base body positioned in the first position in the initial state, and a pair of protrusions protruding from the base body in the projecting direction,
each of the pair of first conductor pieces is provided with an insertion hole into which a corresponding one of the pair of protrusions of the projectile projected is insertable, and
each of the pair of protrusions comes into contact with an edge portion of the insertion hole, switching the first electric circuit from the interrupted state to the conductive state.

5. The electric circuit switching device according to claim 4, wherein
a wedge portion having a wedge shape is formed on a distal end side of each of the pair of protrusions.

6. The electric circuit switching device according to claim 5, wherein
when the pair of protrusions are inserted into the insertion holes respectively, a leg portion of each of the pair of protrusions, the leg portion being positioned closer to the base body side than the wedge portion, is configured to push and widen the insertion hole.

7. The electric circuit switching device according to claim 1, wherein
the piston is disposed in the tubular space in a mode of being restricted in rotation about an axial direction thereof.

8. The electric circuit switching device according to claim 2, wherein
the projectile includes a base body positioned in the first position in the initial state, and a pair of protrusions protruding from the base body in the projecting direction,
each of the pair of first conductor pieces is provided with an insertion hole into which a corresponding one of the pair of protrusions of the projectile projected is insertable, and
each of the pair of protrusions comes into contact with an edge portion of the insertion hole, switching the first electric circuit from the interrupted state to the conductive state.

9. The electric circuit switching device according to claim 3, wherein
the projectile includes a base body positioned in the first position in the initial state, and a pair of protrusions protruding from the base body in the projecting direction,
each of the pair of first conductor pieces is provided with an insertion hole into which a corresponding one of the pair of protrusions of the projectile projected is insertable, and
each of the pair of protrusions comes into contact with an edge portion of the insertion hole, switching the first electric circuit from the interrupted state to the conductive state.

10. The electric circuit switching device according to claim 2, wherein
the piston is disposed in the tubular space in a mode of being restricted in rotation about an axial direction thereof.

11. The electric circuit switching device according to claim 3, wherein
the piston is disposed in the tubular space in a mode of being restricted in rotation about an axial direction thereof.

12. The electric circuit switching device according to claim 4, wherein
the piston is disposed in the tubular space in a mode of being restricted in rotation about an axial direction thereof.

13. The electric circuit switching device according to claim 5, wherein
the piston is disposed in the tubular space in a mode of being restricted in rotation about an axial direction thereof.

14. The electric circuit switching device according to claim 6, wherein
the piston is disposed in the tubular space in a mode of being restricted in rotation about an axial direction thereof.

15. The electric circuit switching device according to claim 8, wherein
the piston is disposed in the tubular space in a mode of being restricted in rotation about an axial direction thereof.

16. The electric circuit switching device according to claim 9, wherein
the piston is disposed in the tubular space in a mode of being restricted in rotation about an axial direction thereof.
